(19) United States
(12) Patent Application Publication
(10) Pub. No.: US 2022/0253471 A1
(43) Pub. Date: Aug. 11, 2022

(54) SYSTEMS AND METHODS TO EVALUATE A COLUMN OF TEXT STRINGS TO FIND RELATIONSHIPS

(71) Applicant: Joseph M. Przechocki, Westfield, MA (US)

(72) Inventor: Joseph M. Przechocki, Westfield, MA (US)

(21) Appl. No.: 17/172,747

(22) Filed: Feb. 10, 2021

(51) Int. Cl. G06F 16/33; G06F 16/31; G06F 16/38; G06K 9/62

(52) U.S. Cl. CPC G06F 16/3344; G06K 9/6215; G06F 16/381; G06F 16/328

(57) ABSTRACT

Embodiments may be associated with an alphanumeric string similarity analysis system implemented via a back-end application computer server. The computer server may receive information about electronic records to be analyzed, wherein each electronic record is associated with enterprise data and includes an electronic record identifier and an alphanumeric string. The computer server may then store the alphanumeric strings in a single column and compute a length of each alphanumeric string in the single column. A two-column result table may be constructed via a self-join on the single column, with shorter strings being stored in a first column of the result table. The result table may be automatically analyzed using cosine similarity to generate a similarity score for an alphanumeric string in the first column and a corresponding string in a second column of the result table. It may then be arranged for indications of the similarity scores to be output.

### TECHNICAL FIELD

The present application generally relates to computer systems and more particularly to computer systems that are adapted to accurately and/or automatically evaluate alphanumeric strings using cosine similarity to find related groups of shorter strings for an enterprise application, such as evaluating a single column of controls to find more verbose versions of simpler controls, or claim descriptions which are more verbose versions of shorter claim statements.

### BACKGROUND

An enterprise, such as a business corporation, may need to analyze alphanumeric “strings.” As used herein, the term “string” may refer to any series of characters such as words, sentences, paragraphs, codes, etc. For example, an enterprise might want to compare a set of strings (e.g., representing job descriptions) to identify which strings may potentially be related (e.g., “Computer access must be authorized by a manager” and “Computer access must be authorized by a department manager”). Typically, an employee of the enterprise will manually review the strings to perform such an analysis. This, however, can be a time consuming and expensive process, especially when a substantial number of strings need to be analyzed. Moreover, it can be difficult to manually and accurately review strings to look for similarity relationships. Similarly, it can be difficult to compare and appropriately respond to various levels of similarities that might be manually detected.

It would be desirable to provide systems and methods to accurately and/or automatically evaluate alphanumeric strings to find related strings where one can see groups of shorter strings compared to related longer strings. Moreover, the alphanumeric string analysis should be easy to access, understand, interpret, update, etc.

### SUMMARY OF THE INVENTION

According to some embodiments, systems, methods, apparatus, computer program code and means are provided to accurately and/or automatically evaluate alphanumeric strings to find related strings in a way that provides fast and accurate results and that allows for flexibility and effectiveness when responding to those results.

Embodiments may be associated with an alphanumeric string similarity analysis system implemented via a back-end application computer server. The computer server may receive information about electronic records to be analyzed, wherein each electronic record is associated with enterprise data and includes an electronic record identifier and an alphanumeric string. The computer server may then store the alphanumeric strings in a single column and compute a length of each alphanumeric string in the single column. A two-column result table may be constructed via a self-join on the single column, with shorter strings being stored in a first column of the result table. The result table may be automatically analyzed using cosine similarity to generate a similarity score for an alphanumeric string in the first column and a corresponding string in a second column of the result table. It may then be arranged for indications of the similarity scores to be output.

Some embodiments comprise: means for receiving, by a computer processor of the back-end application computer server from the input data store, information about electronic records to be analyzed, wherein each electronic record is associated with enterprise data and includes an electronic record identifier and an alphanumeric string; means for storing the alphanumeric strings in a single column; means for computing a length of each alphanumeric string in the single column; means for constructing a two-column result table via a self-join on the single column, with shorter strings being stored in a first column of the result table; means for automatically analyzing the result table using cosine similarity to generate a similarity score for an alphanumeric string in the first column and a corresponding string in a second column of the result table; and means for arranging to output indications of the similarity scores.

In some embodiments, a communication device associated with a back-end application computer server exchanges information with remote devices in connection with an interactive graphical user interface. The information may be exchanged, for example, via public and/or proprietary communication networks.

A technical effect of some embodiments of the invention is an improved and computerized way to accurately and/or automatically evaluate alphanumeric strings using cosine similarity to find related strings in a way that provides fast and accurate results. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of an alphanumeric string similarity analysis system in accordance with some embodiments.

FIG. 2 illustrates an alphanumeric string similarity analysis method according to some embodiments of the present invention.

FIG. 3 is a graph illustrating cosine similarity in accordance with some embodiments.

FIG. 4 is a more detailed method in accordance with some embodiments.

FIG. 5 is a use case in accordance with some embodiments.

FIG. 6A includes a single input column of strings to be analyzed according to some embodiments.

FIG. 6B illustrates analysis results in accordance with some embodiments.

FIG. 7 is an alphanumeric string similarity analysis display according to some embodiments.

FIG. 8 is a block diagram of an apparatus in accordance with some embodiments of the present invention.

FIGS. 9A and 9B are portions of tabular input and result databases according to some embodiments.

FIG. 10 illustrates a tablet computer with an alphanumeric string analysis display according to some embodiments.

### DETAILED DESCRIPTION

Before the various exemplary embodiments are described in further detail, it is to be understood that the present invention is not limited to the particular embodiments described. It is also to be understood that the terminology used herein is for the purpose of describing particular embodiments only, and is not intended to limit the scope of the claims of the present invention.

In the drawings, like reference numerals refer to like features of the systems and methods of the present invention. Accordingly, although certain descriptions may refer only to certain figures and reference numerals, it should be understood that such descriptions might be equally applicable to like reference numerals in other figures.

The present invention provides significant technical improvements to facilitate data analytics associated with alphanumeric string analysis. The present invention is directed to more than merely a computer implementation of a routine or conventional activity previously known in the industry as it provides a specific advancement in the area of electronic record analysis by providing improvements in the operation of a computer system that analyzes similarities in alphanumeric text strings to find related strings. The present invention provides improvement beyond a mere generic computer implementation as it involves the novel ordered combination of system elements and processes to provide improvements in the speed at which such an analysis may be performed. Some embodiments of the present invention are directed to a system adapted to automatically analyze electronic records, aggregate data from multiple sources, automatically identify similar alphanumeric strings, etc. Moreover, communication links and messages may be automatically established, aggregated, formatted, exchanged, etc. to improve network performance (e.g., by reducing an amount of network messaging bandwidth and/or storage required to analyze the strings).

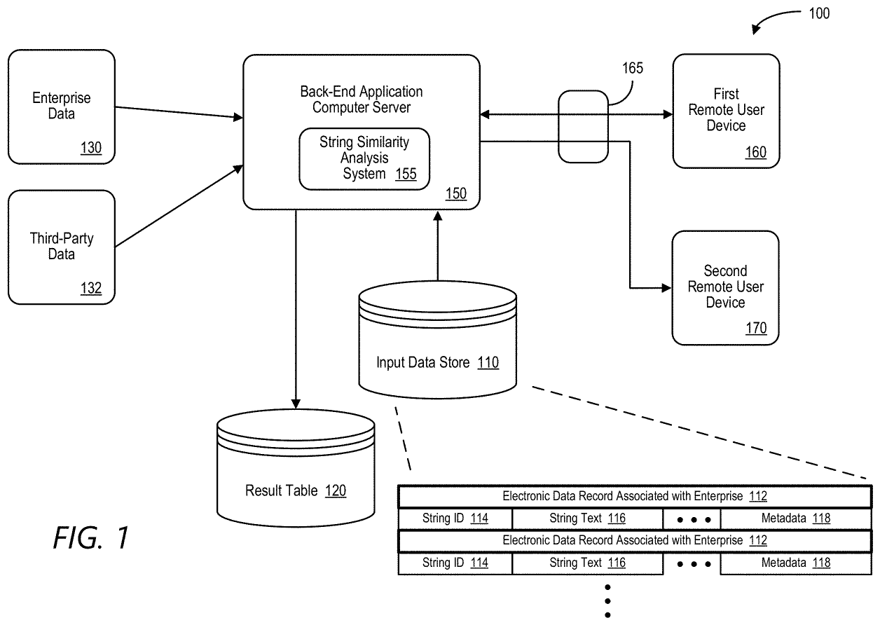

FIG. 1 is a high-level block diagram of an alphanumeric string similarity analysis system 100 according to some embodiments of the present invention. In particular, the system 100 includes a back-end application computer 150 server that may access information in an input data store 110 (e.g., storing a set of electronic records associated with an enterprise 112, each record including, for example, one or more string identifiers 114, string text 116, metadata 218, etc.). The back-end application computer server 150 may also store information into other data stores, such as a result table 120 and utilize a string similarity analysis system 155 to view, analyze, and/or update the electronic records. The back-end application computer server 150 may also exchange information with a first remote user device 160 and a second remote user device 170 (e.g., via a firewall 165). According to some embodiments, an interactive graphical user interface platform of the back-end application computer server 150 (and, in some cases, enterprise data 130 and/or third-party data 132) may facilitate forecasts, decisions, predictions, and/or the display of results via one or more remote administrator computers (e.g., to identify similar strings) and/or the remote user devices 160, 170. For example, the first remote user device 160 may transmit annotated and/or updated information to the back-end application computer server 150. Based on the updated information, the back-end application computer server 150 may adjust data in the input data store 110 and/or the result table 120 and the change may be viewable via the second remote user device 170. Note that the back-end application computer server 150 and/or any of the other devices and methods described herein might be associated with a third party, such as a vendor that performs a service for an enterprise.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate the automated access and/or update of electronic records in the result table 120. As used herein, the term “automated” may refer to, for example, actions that can be performed with little (or no) intervention by a human.

As used herein, devices, including those associated with the back-end application computer server 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the input data store 110 and/or the result table 120. The data elements 110, 120 may be locally stored or reside remote from the back-end application computer server 150. As will be described further below, the input data store 110 may be used by the back-end application computer server 150 in connection with an interactive user interface to access and update electronic records. Although a single back-end application computer server 150 is shown in FIG. 1, any number of such devices may be included. Moreover, various devices described herein might be combined according to embodiments of the present invention. For example, in some embodiments, the back-end application computer server 150 and input data store 110 might be co-located and/or may comprise a single apparatus.

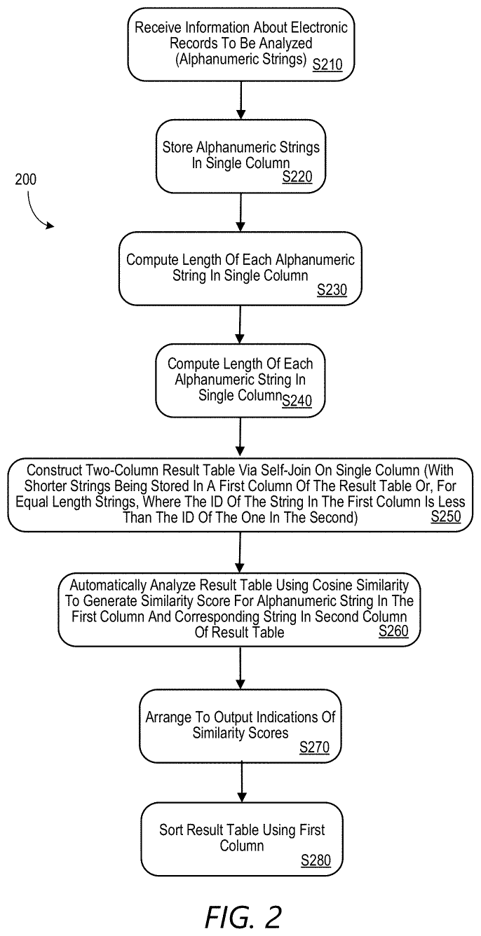

Note that the system 100 of FIG. 1 is provided only as an example, and embodiments may be associated with additional elements or components. According to some embodiments, the elements of the system 100 automatically transmit information associated with an interactive user interface display over a distributed communication network. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a back-end application computer server may receive, from an input data store, information about electronic records to be analyzed. Each electronic record may be associated with, for example, enterprise data and include an electronic record identifier and an alphanumeric string. According to some embodiments, the input data store is associated with a Hadoop big data Hive table. The alphanumeric strings might be associated with, for example, business data of the enterprise, business control statements, insurance information (e.g., insurance claim descriptions), an industry category, medical information (e.g., a description of an injury or medical treatment), etc.

At S220, the system may store the alphanumeric strings in a single column of a table. At S230, the system may clean each string to remove so-called “stop words” and punctuation. As used herein, the phrase “stop words” may refer to words which typically do not carry much significance and therefore can be filtered out before processing natural language data (e.g., text strings). Stop words may include common words in a language, such as “the,” “at,” “this,” etc. At S240, the system may compute a length of each alphanumeric string in the single column of the table. The length might comprise, for example, a character count, word count, etc. At S250, the system may construct a two-column result table via a self-join on the single column, with shorter strings being stored in a first column of the result table. Note that a “join” combines columns from one or more tables in a relational database to create a set that can be saved as a table or used as it is. A self-join is a means for combining columns from one table by using common values. According to some embodiment, the self-join is associated with a Structured Query Language (“SQL”)-type WHERE condition to keep shorter stings to the left in the result table. Moreover, if two strings are of equal length the string with an earlier (lesser) identifier may be kept to the left.

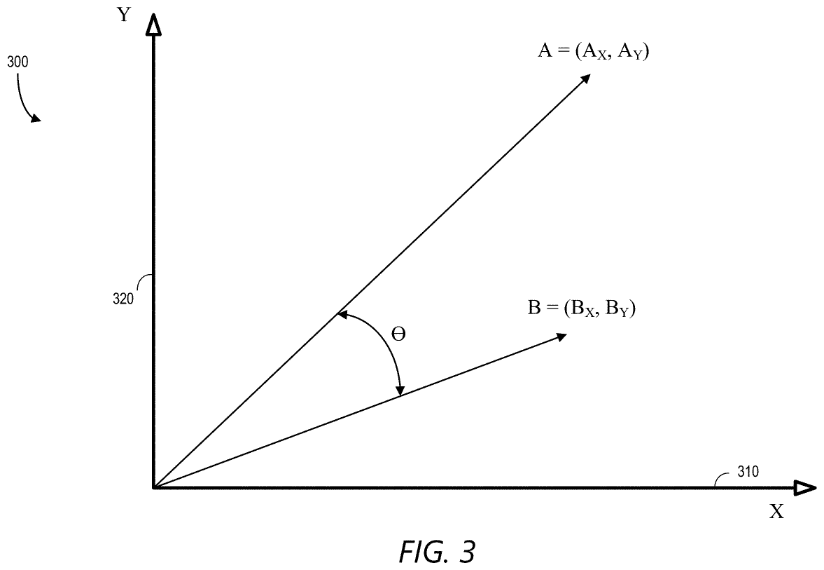

At S260, the system may automatically analyze the result table using cosine similarity (e.g., as explained in connection with FIG. 3) to generate a similarity score for an alphanumeric string in the first column and a corresponding string in a second column of the result table. In this way, an output may indicate groups of short strings related to longer, possibly more verbose, strings. The analysis may include, for example, comparing the similarity scores to a pre-defined threshold value. The back-end application computer server may, in some embodiments, automatically create families of alphanumeric strings based at least in part on these comparisons. For example, the system may automatically replace longer alphanumeric strings with shorter versions from the same family. According to some embodiments, the computation of the length of each alphanumeric string in the single column and/or the construction of the two-column result table via a self-join on the single column may be implemented with a Python or PySpark instruction. For example, the Python or PySpark instruction may be implemented via a User-Defined Function (“UDF”). At S270, the system may arrange to output indications of the similarity scores (e.g., the output indications of similarity scores might be associated with a Hadoop big data Hive table). At S280, the system may sort the result table using the first column in order to generate blocks of related strings. The first column may be considered, for example, as a representation of a family of long (or more verbose) text strings located in another column.

Some embodiments described herein use “cosine similarity” to analyze how similar two text strings are to each other. FIG. 3 is a graph 300 illustrating cosine similarity in accordance with some embodiments. The graph 300 includes an X axis 310 and a Y axis 320 along with two vectors: vector A (extending from the origin to point A_{X}, A_{Y}) and vector B (extending from the origin to point B_{X}, B_{Y}). An angle Θ is defined between vector A and vector B. Note that the definition of a vector dot product is:

A·B=∥A∥∥B∥ cos(θ)

As a result, cosine similarity may be represented by:

$$cos ( θ ) = \frac{A \cdot B}{‖ A ‖ ‖ B ‖}$$

Moreover, the right-hand side of the above equation is easily calculated when using word counts as vector components for a string:

A·B=A_{X}B_{X}+A_{Y}B_{Y}

(which is scalar in nature);

∥A∥=\sqrt{A_{X}²+A_{Y}²}; and

∥B∥=\sqrt{B_{X}²+B_{Y}²}.

Now consider a text string, such as a phrase, to be a vector. In this case, cosine similarity may a measure of similarity between two phrases (non-zero vectors) of an inner product space. It is equal the cosine of the angle between the vectors, which is also the same as the inner product of the same vectors normalized to both have length 1. Note that cosine of 0° is 1 (when the vectors overlap and are identical). Two vectors oriented at 90° relative to each other have a similarity of 0 (that is they are not similar at all). Note that this idea applies for any number of dimensions (not just the two-dimensional example illustrated in the graph 300 of FIG. 3), and cosine similarity is commonly used in high-dimensional positive spaces. For example, each word in a string may be assigned a different dimension and the string may be characterized by a vector where the value in each dimension corresponds to the number of times the word appears in the string. Cosine similarity then gives a useful measure of how similar two strings are likely to be (e.g., in terms of their subject matter).

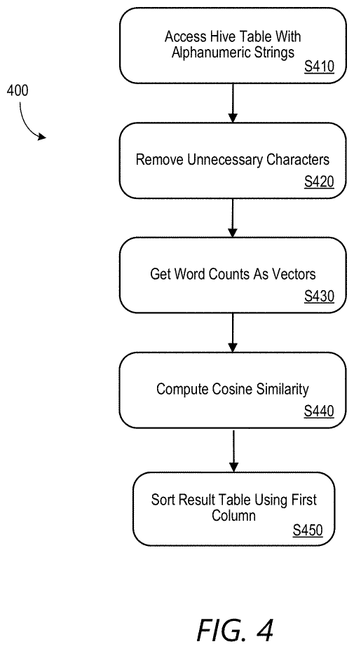

FIG. 4 is a more detailed method 400 that may be used to create a result table in accordance with some embodiments. At S410, the system may access a Hive table. At S420, the system may automatically remove unnecessary alphanumeric characters. For example, a function may remove unnecessary punctuation marks, simple words such as “a” and “the,” etc. At S430, the system may create a self-join with WHERE condition to create two-columns (with shorter strings kept in first column or earlier/lesser IDs kept in first column). At S440, the system may calculate word counts as vectors. In some embodiments, a function may automatically obtain word counts (e.g., how many times was the word “money” used) to create string vectors. At S450, the system may calculate the cosine similarity scores. For example, a function may automatically compute cosine similarity as described in connection with FIG. 3. At S460, the system may sort the result table using the first column in order to generate blocks of related strings (e.g., the first column may be considered as a representation of a family of longer text strings).

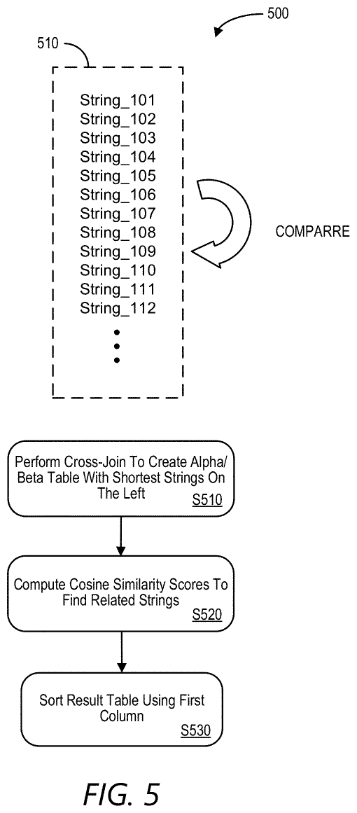

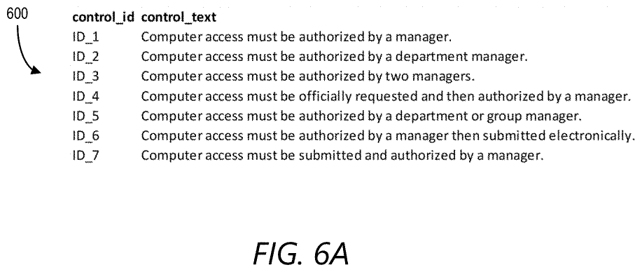

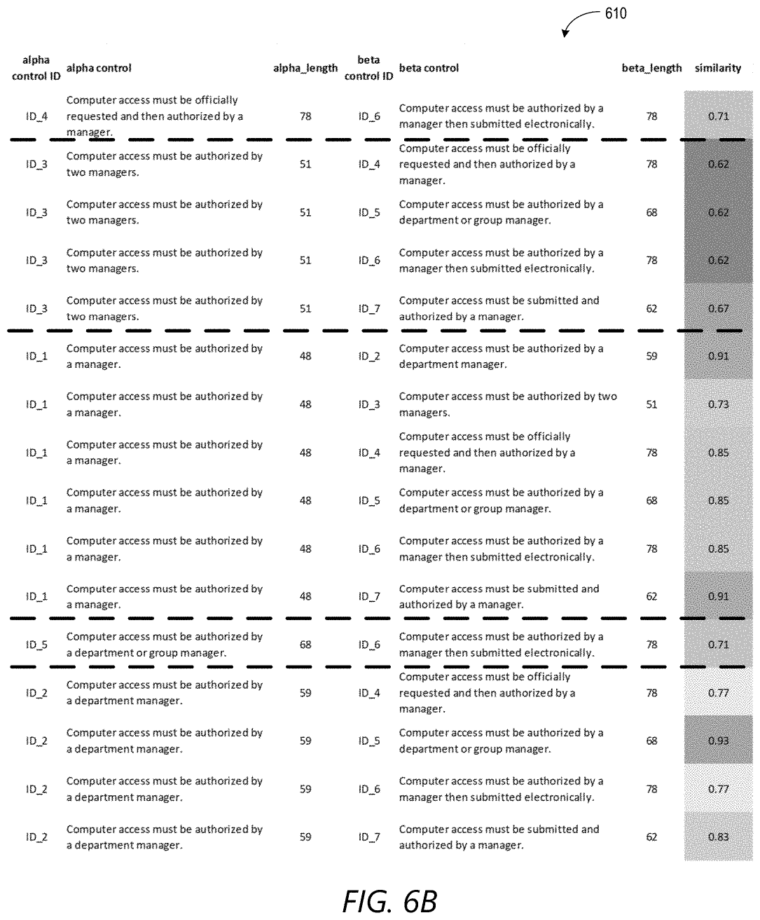

FIG. 5 is a use case 500 in accordance with some embodiments. In this example, text strings in a set 510 (e.g., string_101, string_102, . . . ) are compared to each other. At S510, the system performs a cross join to create a table with alpha and beta columns with the shortest strings being placed in the alpha column. At S520, the system computes cosine similarity scores to find related strings. For example, text strings that are very similar may be variants of what should be identical phrases (and could therefore be modified to reduce the overall number of unique strings in the set 510). At S530, the system may sort the result table using the first column in order to generate blocks of related strings (e.g., the first column may be considered as a representation of a family of longer text strings). For example, FIG. 6A is a one-column table 600 (that is, there is one column of text strings) according to some embodiments. The table 600 may, for example, be associated with a realistic insurance industry example of an input control list with possible strings which are more verbose versions of earlier recorded strings. The table 600 includes a “control_ID” column and a “control_text” column as a hypothetical generic sample of input list of control statement strings that might be compared to each other. Overtime, new text strings maybe created by the enterprise with new IDs and may involve copying and editing of previous strings. Later, as the list grows, the enterprise may wish to find which text strings relate to others, how loosely they are related, which strings are the simpler representatives of derivate work, etc.

FIG. 6B illustrates analysis results 610 in accordance with some embodiments. The results 610 may, for example, be associated with a realistic insurance industry example of a table showing blocks of shorter (simpler) strings which have been matched to similar longer strings. The results 610 include an alpha control ID column, an alpha control text column, an alpha length column (e.g., a character count), a beta control ID column, a beta control text column, a beta length column, and a similarity score. The alpha and beta data might be created, for example, after a self-join is performed on the table 600 of FIG. 6A. The dashed lines in FIG. 6B separate different potential families of strings based on the alpha control ID. For example, the family associated with “ID_1” might be associated with strings “ID_2,” “ID_3,” “ID_4,” “ID_5,” “ID_6,” and “ID_7”). The results 610 show the cosine similarity and family matching of a single list of control statement strings after a second column is created by a self-join of the first column with itself. The results 610 are also arranged using a condition to keep the shorter strings on left side. The cosine similarity is computed for each row, and the results can be sorted in various ways. Note that when keeping the left string in groups, families of related strings may emerge. An enterprise may also choose a meaningful threshold value of that score metric such that scores above a certain number will be taken to represent a family of related strings. Then a user might manually investigate why some families exist, if some near duplicate text strings are simply more verbose versions of other strings, etc.

Thus, embodiments may provide a method that uses PySpark column-wise functions to compute cosine similarity to determine which alphabetical strings in a single list of alphabetical strings (such as control statement inventory or insurance claim descriptions) are related to each other in terms of word use. The results may be provided in pairs of string comparisons, with the shorter and possibly more succinct string on the left, resulting in related sets.

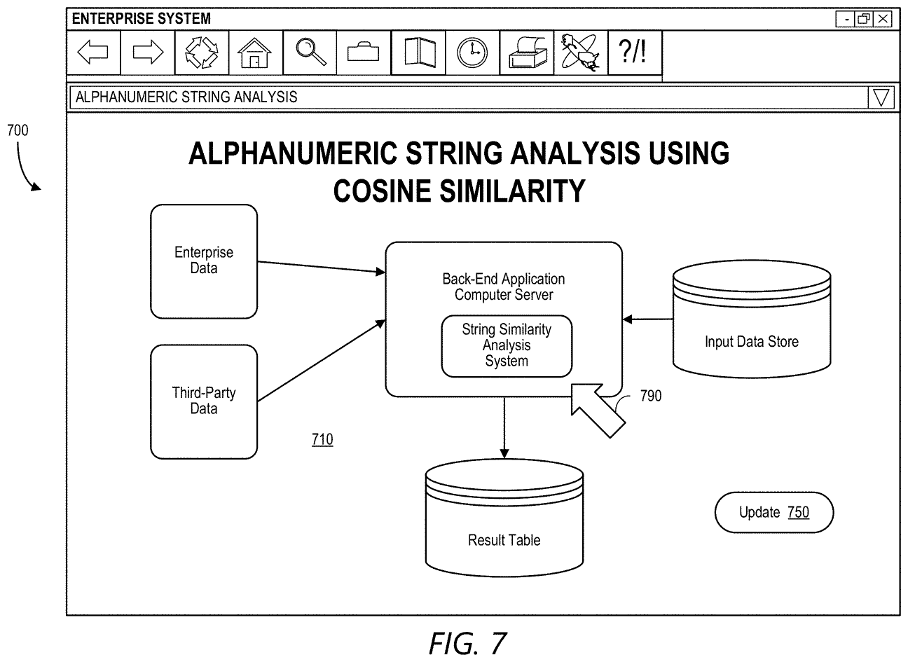

The data analyzed by the system may then be presented on a Graphical User Interface (“GUI”). For example, FIG. 7 is an alphanumeric string similarity analysis display 700 including graphical representations of elements of an analysis system 710 according to some embodiments. Selection of a portion or element of the display 700 might result in the presentation of additional information about that portion or element (e.g., a popup window presenting a data source or result table) or let an operator or administrator enter or annotate additional information about text strings (e.g., based on his or her experience and expertise). Selection of an “Update” icon 750 (e.g., by touchscreen or computer mouse pointer 790) might cause the system or platform to re-analyze the alphanumeric string data.

Note that in the insurance industry it may be useful to compare a single list of strings (such as phrases, sentences, or paragraphs) with itself. One example would be to compare a single list of audit controls with itself to check if some controls are similar and to present the results with the shorter (and possibly more succinct) version on the left of a two-column result table. The related (and more verbose) versions may be present on the right side of the table. Such a method could be useful to find redundancies within control inventory.

Another example would be to compare a list of claim descriptions against itself to find strings that are similar and possibly more verbose versions of other claim descriptions which have been submitted. In so doing, one could potentially identify claims that should be investigated, formalize and standardize claim descriptions, etc.

As described in connection with FIG. 3, in mathematics there is a known calculation to find how much of one vector in the XY plane points in the same direction of another vector in the XY plane. To do so, the system multiplies the magnitude of both vectors together by the cosine of the angle between them. Furthermore, programming may generalize this math of two XY-vectors to that of two strings. Essentially, the system creates a mathematical multi-dimensional vector representing each string based on the count of each word which is used. These mathematical multi-dimensional vectors can be used in a similar way as the simple two-dimensional ones explained in connection with FIG. 3. This text analytics technique, called cosine similarity, produces a single numerical metric of how similar one string is to another. Some embodiments described herein use UDFs in PySpark to perform these steps on entire columns of Hive tables in Hadoop.

Since cosine similarity requires two vectors in order to compute a metric, the system provides two vectors to any such coding. A starting point comprise a single list of strings, therefore the system may create a second column where it matches up each string in the initial column with each other member. It may be advantageous to only do this once, in other words compare string A to B and not also B to A since the comparison metric would be the same. In some embodiments, the system is coded such that the shorter of the two strings (if there is a difference in length) is kept in the left column and the longer string will be in the right. Therefore, the system will compare either equal-length strings or shorter-to-longer length strings.

Some embodiments may use a PySpark data frame cross join of the single input column to compute two columns of strings. A single column of strings can be cross joined with itself to create all pairing combinations, resulting in two columns of strings. Furthermore, such a cross join result can be specified to retain only shorter strings on the left. Cosine similarity can then be computed as well as the length of the strings. By ordering the results of pairs that have a similarity over a threshold value, and by having the shortest strings on the left side of the table as part of the computation process, the resultant columns may show similar string pairs with the most succinct versions on the left and more verbose versions on the right side. The algorithm might be coded using PySpark UDFs which allow for column-wise operations to be written thereby relieving the need for explicit loops to retrieve and process each row. The results may then be presented in a Hadoop Hive table.

By using this algorithm to process a library of control text strings, the output can be used to visualize which controls are related and furthermore which ones can be represented by a more succinct version. This may let a user maintain the list of controls strings to guard against redundancies that may occur with multiple authors. Additional applications could involve applying this to a long list of insurance claim descriptions (to see which ones are similar and perhaps edited versions of others), job or industry descriptions, injury or treatment descriptions, etc.

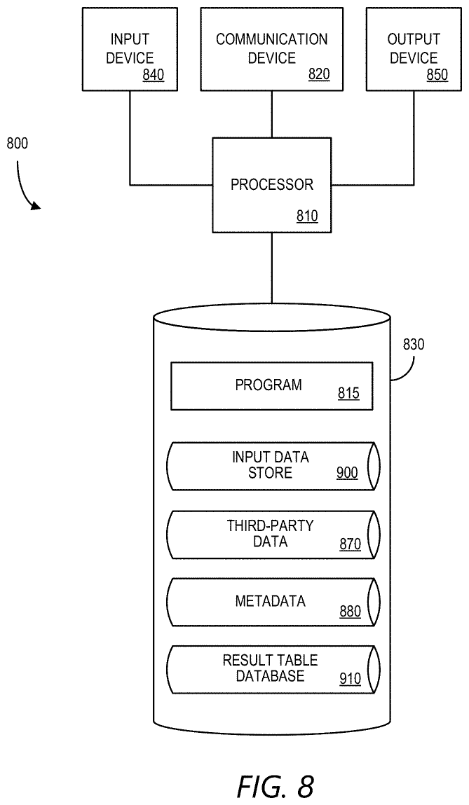

The embodiments described herein may be implemented using any number of different hardware configurations. For example, FIG. 8 illustrates an apparatus 800 that may be, for example, associated with the system 100 described with respect to FIG. 1. The apparatus 800 comprises a processor 810, such as one or more commercially available Central Processing Units (“CPUs”) in the form of one-chip microprocessors, coupled to a communication device 820 configured to communicate via a communication network (not shown in FIG. 8). The communication device 820 may be used to communicate, for example, with one or more remote third-party alphanumeric string suppliers, administrator computers, and or communication devices (e.g., PCs and smartphones). Note that communications exchanged via the communication device 820 may utilize security features, such as those between a public internet user and an internal network of an insurance company and/or an enterprise. The security features might be associated with, for example, web servers, firewalls, and/or PCI infrastructure. The apparatus 800 further includes an input device 840 (e.g., a mouse and/or keyboard to enter information about data sources, unneeded character rules, third-parties, etc.) and an output device 850 (e.g., to output reports regarding analysis results, recommended changes, alerts, etc.).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 815 and/or a similarity analysis tool or application for controlling the processor 810. The processor 810 performs instructions of the program 815, and thereby operates in accordance with any of the embodiments described herein. For example, the processor 810 may receive information about electronic records to be analyzed, wherein each electronic record is associated with enterprise data and includes an electronic record identifier and an alphanumeric string. The processor 810 may then store the alphanumeric strings in a single column and compute a length of each alphanumeric string in the single column. A two-column result table may be constructed by the processor 810 via a self-join on the single column, with shorter strings being stored in a first column of the result table. The result table may be automatically analyzed by the processor 810 using cosine similarity to generate a similarity score for an alphanumeric string in the first column and a corresponding string in a second column of the result table. The processor 810 may then arrange for indications of the similarity scores to be output.

The program 815 may be stored in a compressed, uncompiled and/or encrypted format. The program 815 may furthermore include other program elements, such as an operating system, a database management system, and/or device drivers used by the processor 810 to interface with peripheral devices.

As used herein, information may be “received” by or “transmitted” to, for example: (i) the back-end application computer server 800 from another device; or (ii) a software application or module within the back-end application computer server 800 from another software application, module, or any other source.

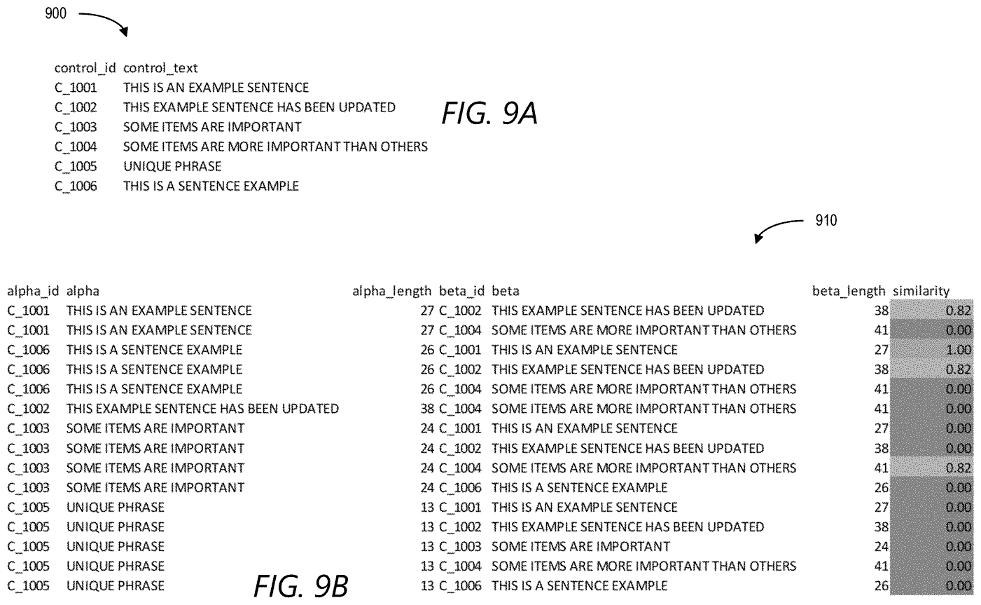

In some embodiments (such as shown in FIG. 8), the storage device 830 further stores an input data store 1000 (e.g., with enterprise text strings), third-party data 870 (e.g., with third-party text strings), metadata 880 (e.g., regarding who created various strings, when the strings were created, where the strings were stored, etc.), and a result table database 1010. An example of database that might be used in connection with the apparatus 800 will now be described in detail with respect to FIGS. 9A and 9B. Note that the database described herein is only an example, and additional and/or different information may be stored therein. Moreover, various databases might be split or combined in accordance with any of the embodiments described herein. For example, the result table database 1010 might be combined and/or linked to each other within the program 815.

Referring to FIGS. 9A and 9B, tables are shown that represents the input data store 900 and the result table database 910 that may be stored at the apparatus 800 according to some embodiments. The input data store 900 may include a control_id column and a control_text column. Note that the control_text (e.g., alphanumeric strings) associated with “C_1001” and “C_1006” are identical after stop words “an” and “a” are removed. The result table database 910 may include an alpha_id, an alpha string, an alpha_length, a beta_id, a beta string, a beta_length, and a similarity score. Note that the similarity score of the third row equals “1.00” indicating that the text associated with C_1001 and C_1006 are an exact match.

Thus, embodiments may provide an automated and efficient way to determine the similarity of text strings (e.g., associated with various insurers, third-parties, etc.) and provide results in way that can be easily understood and utilized. A self-join may be performed on a single column of elements (strings) to pair each with each other. Moreover, embodiments may only keep those where the shortest one is on the left, or in the case of when the strings are of the same length to then keep the one with an earlier identifier on the left. Cosine similarity computations may then be used to sort the table to keep all groups of a parent string (the left string) together for easy reader review of which short string has related longer string versions. Embodiments may also provide an ability to access and interpret data in a holistic, tactical fashion. According to some embodiments, the system may be agnostic regarding particular web browsers, sources of information, etc. For example, information from multiple sources (e.g., an internal insurance policy database and an external data store) might be blended and combined (with respect to reading and/or writing operations) so as to appear as a single “pool” of information to a user at a remote device. Moreover, embodiments may be implemented with a modular, flexible approach such that deployment of a new system for an enterprise might be possible relatively quickly.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to types of enterprises, embodiments may instead be associated with other types of enterprises in additional to and/or instead of those described herein. Similarly, although certain attributes were described in connection some embodiments herein, other types of attributes might be used instead.

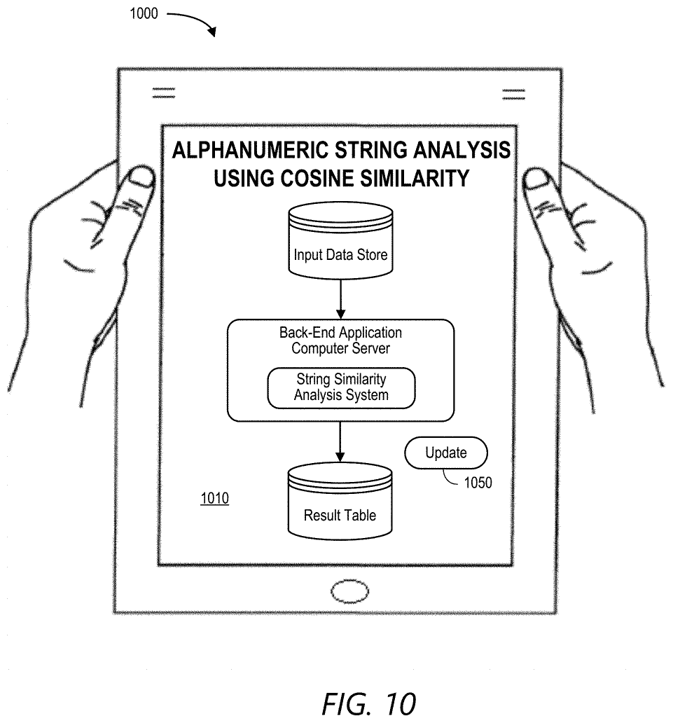

Note that the displays and devices illustrated herein are only provided as examples, and embodiments may be associated with any other types of user interfaces. For example, FIG. 10 illustrates a tablet computer 1000 with an alphanumeric string analysis display 1010 according to some embodiments. The alphanumeric string analysis display 1010 shows elements of a similarity detection system that might include selectable data that can be modified by a user of the handheld computer 1000 (e.g., via an “Update” icon 1050) to view updated alphanumeric string analysis result data associated with an enterprise (e.g., including, in some embodiments, similarity information).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An alphanumeric string similarity analysis system implemented via a back-end application computer server, comprising:
(a) an input data store that contains electronic records, each electronic record being associated with enterprise data and including an electronic record identifier and an alphanumeric string;
(b) the back-end application computer server, coupled to the input data store, including:
a computer processor, and
a computer memory, coupled to the computer processor, storing instructions that, when executed by the computer processor cause the back-end application computer server to:
receive, from the input data store, information about electronic records to be analyzed, including alphanumeric strings,
store the alphanumeric strings in a single column,
compute a length of each alphanumeric string in the single column,
construct a two-column result table via a self-join on the single column, with shorter strings being kept in a first column of the result table,
automatically analyze the result table using cosine similarity to generate a similarity score for an alphanumeric string in the first column and a corresponding string in a second column of the result table, and
arrange to output indications of the similarity scores; and
(c) a communication port coupled to the back-end application computer server to facilitate a transmission of data with remote user devices to support interactive user interface displays, including the similarity scores, via a distributed communication network.

2. The system of claim 1, wherein the self-join is associated with a Structured Query Language (“SQL”)-type WHERE condition to keep shorter stings to the left in the result table.

3. The system of claim 1, wherein said analysis includes comparing the similarity scores to a pre-defined threshold value and automatically creating families of alphanumeric strings based at least in part on said comparisons.

4. The system of claim 1, wherein the back-end application computer server removes stop words from the alphanumeric strings before computing the length of each alphanumeric string.

5. The system of claim 4, wherein the back-end application computer server automatically replaces longer alphanumeric strings with shorter versions from the same family.

6. The system of claim 1, wherein at least one of the computation of the length of each alphanumeric string in the single column and the construction of the two-column result table via a self-join on the single column is associated with a PySpark instruction.

7. The system of claim 6, wherein the PySpark instruction is associated with a user-defined function.

8. The system of claim 1, wherein the alphanumeric strings are associated with at least one of: (i) business data of the enterprise, (ii) business control statements, (iii) insurance information, (iv) insurance claim descriptions, (v) an industry category, and (vi) medical information.

9. The system of claim 1, wherein the output indications of similarity scores are associated with a Hadoop big data Hive table.

10. A computerized alphanumeric string similarity analysis method implemented via a back-end application computer server, comprising:
receiving, by a computer processor of the back-end application computer server from the input data store, information about electronic records to be analyzed, wherein each electronic record is associated with enterprise data and includes an electronic record identifier and an alphanumeric string;
storing the alphanumeric strings in a single column;
computing a length of each alphanumeric string in the single column;
constructing a two-column result table via a self-join on the single column, with shorter strings being stored in a first column of the result table;
automatically analyzing the result table using cosine similarity to generate a similarity score for an alphanumeric string in the first column and a corresponding string in a second column of the result table; and
arranging to output indications of the similarity scores.

11. The method of claim 10, wherein the input data store is associated with a Hadoop big data Hive table.

12. The method of claim 10, wherein said analysis includes comparing the similarity scores to a pre-defined threshold value and automatically creating families of alphanumeric strings based at least in part on said comparisons.

13. The method of claim 10, wherein the back-end application computer server removes stop words from the alphanumeric strings before computing the length of each alphanumeric string.

14. The method of claim 13, wherein the back-end application computer server automatically replaces longer alphanumeric strings with shorter versions from the same family.

15. The method of claim 10, wherein at least one of the computation of the length of each alphanumeric string in the single column and the construction of the two-column result table via a self-join on the single column is associated with a PySpark instruction.

16. The method of claim 15, wherein the PySpark instruction is associated with a user-defined function.

17. The method of claim 10, wherein the alphanumeric strings are associated with at least one of: (i) business data of the enterprise, (ii) business control statements, (iii) insurance information, (iv) insurance claim descriptions, (v) an industry category, and (vi) medical information.

18. The method of claim 10, wherein the output indications of similarity scores are associated with a Hadoop big data Hive table.

19. A non-transitory, computer-readable medium storing instructions, that, when executed by a processor, cause the processor to perform an alphanumeric string similarity analysis method implemented via a back-end application computer server, the method comprising:
receiving, by a computer processor of the back-end application computer server from the input data store, information about electronic records to be analyzed, wherein each electronic record is associated with enterprise data and includes an electronic record identifier and an alphanumeric string;
storing the alphanumeric strings in a single column;
computing a length of each alphanumeric string in the single column;
constructing a two-column result table via a self-join on the single column, with shorter strings being stored in a first column of the result table;
automatically analyzing the result table using cosine similarity to generate a similarity score for an alphanumeric string in the first column and a corresponding string in a second column of the result table; and
arranging to output indications of the similarity scores.

20. The medium of claim 19, wherein the input data store is associated with a Hadoop big data Hive table.

21. The medium of claim 20, wherein said analysis includes comparing the similarity scores to a pre-defined threshold value and automatically creating families of alphanumeric strings based at least in part on said comparisons.

22. The medium of claim 21, wherein at least one of the computation of the length of each alphanumeric string in the single column and the construction of the two-column result table via a self-join on the single column is associated with a PySpark user-defined function.
